(19) United States
(12) Patent Application Publication
(10) Pub. No.: US 2016/0077892 A1
(43) Pub. Date: Mar. 17, 2016

(54) Automatic Sensor Selection Based On Requested Sensor Characteristics

(71) Applicant: Microsoft Corporation, Redmond, WA (US)

(72) Inventors: Pradipta Ariyo Bhaskoro Hendri, Bellevue, WA (US); Ying Guo, Kirkland, WA (US); Osama M. Salem, Redmond, WA (US)

(21) Appl. No.: 14/485,548

(22) Filed: Sep. 12, 2014

(51) Int. Cl. G06F 9/54; G01D 9/00

(52) U.S. Cl. CPC G06F 9/54; G01D 9/00

(57) ABSTRACT

A computing device can include or receive data from one or more sensors. Each sensor provides data regarding the environment in which the computing device is located, or the manner in which the computing device is situated or present in the environment. The computing device also includes one or more programs that make use of data received from the sensors. A sensor system of the computing device presents a sensing priority interface that allows a program to request aggregated data from the sensors. The program provides, as a parameter of the interface, an indication of sensor characteristics that are to have priority. The sensor system determines, based on the sensors supported by the computing device and the indication provided by the program, which sensors to use to obtain the aggregated data. The sensor system activates the appropriate sensors, and returns the requested aggregated data to the requesting program.

### BACKGROUND

As computing technology has advanced, computers have become increasingly relied upon to perform many different functions. One such function, particularly in mobile computers, is sensing information about the computer's environment or position. This sensing can be performed based on different sensors, such as accelerometers, gyroscopes, magnetometers, and so forth. This sensed information can be used in different manners by various different programs on the computer. However, as different computers can have different sensors that operate in different manners, it can be difficult at times for the developer of a program to know how to obtain the sensing information desired to be used by the program.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a sensing priority interface is exposed and has a parameter that is an indication of one or more sensor characteristics that are to be prioritized. In response to the sensing priority interface being invoked by a program, one or more of multiple sensors from which sensor data is to be aggregated are identified based on the indication of the one or more sensor characteristics that are to be prioritized. The sensor data from the one or more sensors is aggregated, and the aggregated data is returned to the program.

In accordance with one or more aspects, a computing device includes a processing system comprising one or more processors, and one or more computer-readable storage media having stored thereon multiple instructions that, when executed by the processing system, cause the processing system to perform acts. These acts include exposing a sensing priority interface receiving as a parameter an indication of which of multiple sensor characteristics are to be prioritized. The acts further include, in response to the sensing priority interface being called by a program of the computing device, identifying one or more of multiple sensors based on the indication of which of multiple sensor characteristics are to be prioritized, aggregating sensor data from the one or more sensors, and returning the aggregated data to the program.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is a block diagram illustrating an example computing device implementing the automatic sensor selection based on requested sensor characteristics in accordance with one or more embodiments.

FIG. 2 is a flowchart illustrating an example process for implementing the automatic sensor selection based on requested sensor characteristics in accordance with one or more embodiments.

FIG. 3 illustrates an example system in which the automatic sensor selection based on requested sensor characteristics can be implemented in accordance with one or more embodiments.

FIG. 4 illustrates an example user interface that can be displayed to a user to allow the user to select whether to use sensor data in accordance with one or more embodiments.

FIG. 5 illustrates an example system that includes an example computing device that is representative of one or more systems and/or devices that may implement the various techniques described herein.

### DETAILED DESCRIPTION

Automatic sensor selection based on requested sensor characteristics is discussed herein. A computing device can include or receive data from one or more sensors. Each sensor provides data regarding the environment in which the computing device is located, or the manner in which the computing device is situated or present in the environment (e.g., a position or orientation of the computing device). These sensors have various different characteristics such as power usage (the amount of power used by the sensor in obtaining data), latency (the amount of time it takes for the sensor to provide data after being activated), accuracy (the accuracy of the data provided by the sensor), and so forth.

The computing device also includes one or more programs that make use of data received from the sensors. Different programs can desire different data from the sensors, and have different desires regarding which sensor characteristics are to have priority. For example, one program may desire accurate position data and be less concerned with the amount of power used to obtain the position data or the amount of time it takes to obtain the position data, and another program may desire position data quickly and be less concerned with the accuracy of the position data or the amount of power used to obtain the position data.

A sensor system of the computing device (e.g., part of an operating system of the computing device) presents a sensing priority interface that allows a program to request aggregated data (e.g., position or orientation data). The program provides, as a parameter of the interface, an indication of one or more sensor characteristics that are to have priority. The sensor system determines, based on the sensors supported by the computing device and the indication provided by the program, which sensors to use (and optionally which operational mode of the sensors to use) to obtain the requested aggregated data. The sensor system activates the appropriate sensors, and returns the requested aggregated data to the requesting program.

Thus, the sensor system provides advantageously provides an interface that allows the programs to request sensor data and provide an indication of the sensor characteristics that are important to the program, and alleviates the program of knowing which sensors are supported by the computing device and which of those sensors to use to satisfy the desired sensor characteristics. The sensor system advantageously allows the program to have no prior or run-time knowledge of the sensors supported by the computing device running the program. The techniques discussed herein advantageously improve usage of programs on the computing device due to the programs being provided with sensor data based on sensor characteristics that are important to the program, and can advantageously increase power savings in the computing device by allowing power usage characteristics to be prioritized by the programs.

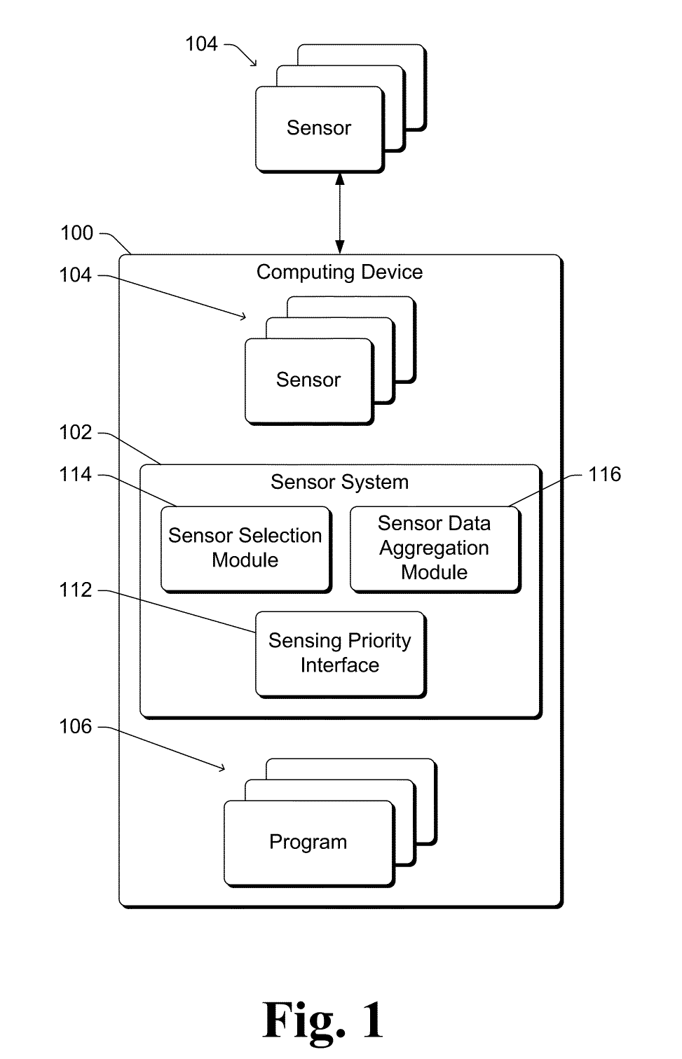

FIG. 1 is a block diagram illustrating an example computing device 100 implementing the automatic sensor selection based on requested sensor characteristics in accordance with one or more embodiments. The computing device 100 can be a variety of different types of devices, such as a desktop computer, a server computer, a laptop or netbook computer, a tablet or phablet device, a notepad computer, a mobile station, an entertainment appliance, a set-top box communicatively coupled to a display device, a television or other display device, a cellular or other wireless phone, a game console, an automotive computer, and so forth. Thus, the computing device 100 may range from a full resource device with substantial memory and processor resources (e.g., personal computers, game consoles) to a low-resource device with limited memory and/or processing resources (e.g., traditional set-top boxes, hand-held game consoles).

The computing device 100 includes a sensor system 102, one or more sensors 104, and one or more programs 106. In one or more embodiments, the sensor system 102 is implemented as part of an operating system of the computing device 100, although the sensor system 102 can alternatively be implemented as part of other components or modules of the computing device 100. The sensor system 102 automatically selects sensors from which sensor data is to be aggregated and returned to a requesting program, the automatic selection being based on sensor characteristics requested by the program. Each sensor 104 provides data regarding the environment in which the computing device 100 is located, or the manner in which the computing device 100 is situated or present in the environment (e.g., a position or orientation of the computing device 100, a speed of movement of the computing device 100, a direction of movement of the computing device 100, and so forth). One or more of the sensors 104 can optionally be implemented in another device physically separate from the computing device 100, but still communicate sensor data to the computing device 100.

The sensor system includes a sensing priority interface 112, a sensor selection module 114, and a sensor data aggregation module 116. The sensing priority interface 112 is an interface that can be called or otherwise invoked by a program 106, and receives from the program 106 as a parameter an indication of one or more sensor characteristics that are to be prioritized. These one or more sensor characteristics that are to be prioritized are the one or more sensor characteristics that are important to the program 106 (e.g., to the developer of the program 106). Different programs 106 can provide as the parameter an indication of different sensor characteristics that are to be prioritized.

The sensors 104 can have various different characteristics such as power usage (the amount of power used by the sensor in obtaining data), latency (the amount of time it takes for the sensor to provide data after being activated), accuracy (the accuracy of the data provided by the sensor), and so forth. The sensor selection module 114 determines, based on the one or more sensor characteristics indicated by the program 106 as well as the different sensor characteristics of the sensors 104, one or more sensors 104 to activate.

The sensor data aggregation module 116 obtains sensor data from the activated ones of the sensors 104, and aggregates the obtained sensor data. Aggregating the obtained sensor data refers to combining the sensor data so that a combined value is returned to the program 106 rather than the individual sensor data. For example, the aggregated value can be an indication of the position or orientation of the computing device 100 in 3-dimensional (3D) space, a speed of movement of the computing device 100, a direction of movement of the computing device 100, and so forth.

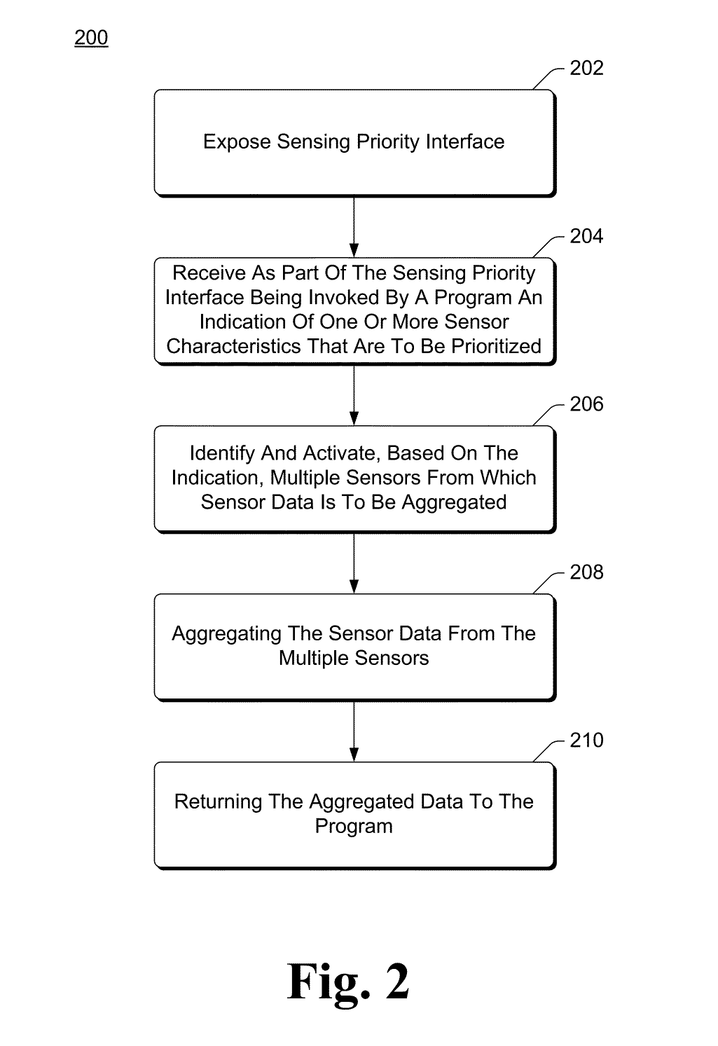

FIG. 2 is a flowchart illustrating an example process 200 for implementing the automatic sensor selection based on requested sensor characteristics in accordance with one or more embodiments. Process 200 is carried out by a sensor system of a computing device, such as the sensor system 102 of FIG. 1, and can be implemented in software, firmware, hardware, or combinations thereof. Process 200 is shown as a set of acts and is not limited to the order shown for performing the operations of the various acts. Process 200 is an example process for implementing the automatic sensor selection based on requested sensor characteristics; additional discussions of implementing the automatic sensor selection based on requested sensor characteristics are included herein with reference to different figures.

In process 200, the sensor system exposes a sensing priority interface (act 202). This sensing priority interface is, for example, sensing priority interface 112 of FIG. 1. In one or more embodiments, the sensing priority interface is a method of an application programming interface (API), such as a SetSensingPriority( ) method that takes as a parameter an indication of one or more sensor characteristics that are to be prioritized. However, it should be noted that the sensing priority interface can be implemented in any of a variety of other manners that allows a program to request data and provide an indication of one or more sensor characteristics that are to be prioritized.

As part of the exposed sensing priority interface being invoked by a program, the sensor system receives an indication of one or more sensor characteristics that are to be prioritized (act 204). It should be noted that the program invoking the sensing priority interface need not, and typically does not, identify which particular sensors to use. Rather, the program indicates one or more sensor characteristics that are to be prioritized, and relies on the sensor system to use the appropriate sensors so that the indicated one or more sensor characteristics are prioritized.

Various different sensor characteristics can be prioritized, such as heading accuracy, rotation rate accuracy, spatial distance accuracy, calorie expenditure impact accuracy, latency of sensing data, power impact of sensing system, and central processing unit (CPU) usage of sensing system. Any one or more of these sensor characteristics can be prioritized. It should be noted, however, that these sensor characteristics are examples of sensor characteristics that can be prioritized, and that other sensor characteristics can additionally or alternatively be prioritized. A sensor characteristic being prioritized refers to an accurate value for that sensor characteristic being desired, or operation of one or more sensors in a manner that conforms or adheres to the particular sensor characteristic.

Prioritizing heading accuracy refers to an accurate indication of the heading (e.g., compass direction) in which the computing device is moving or pointed being desired by the program. Prioritizing rotation rate accuracy refers to an accurate indication of the rate of rotation (and optionally which of one or more device axes about which the rotation occurs) being desired by the program. Prioritizing spatial distance accuracy refers to an accurate indication of distance moved by the computing device over some amount of time being desired by the program.

Prioritizing calorie expenditure impact accuracy refers to an accurate indication of the number of calories expended by a user of the computing device over some amount of time being desired by the program. Prioritizing latency of sensing data refers to receiving sensor data quickly being desired by the program. Prioritizing power impact of sensing system refers to a reduced or small amount of power being expended by the sensors in providing sensor data being desired by the program. Prioritizing central processing unit (CPU) usage of sensing system refers to a reduced or small amount of CPU processing capabilities being used in providing sensor data being desired by the program.

In one or more embodiments, the sensor system supports a single type of aggregated value, such as an indication of the position or orientation of the computing device in 3D space. Alternatively, the sensor system may support multiple different types of aggregated values, such as an indication of the position or orientation of the computing device in 3D space, an indication of speed of movement of the computing device, and so forth. In such situations, the sensing priority interface can also have, as a second parameter provided by the program, an indication of which type of aggregated value is desired by the program. Or, the sensor system may include multiple sensing priority interfaces, one sensing priority interface for each different type of aggregated value so the program invokes the appropriate one of the multiple sensing priority interfaces rather than providing an indication of which type of aggregated value is desired by the program.

In one or more embodiments, the program may provide no indication of sensor characteristics that are to be prioritized. In this situation, the program defers to the sensor system to determine which sensor characteristics are to be prioritized. The sensor system can have one or more default sensor characteristics that are prioritized, or alternatively can use various other rules or criteria to determine which sensor characteristics are prioritized.

In response to the sensing priority interface being invoked, the sensor system identifies and activates, based on the received indication of one or more sensor characteristics that are to be prioritized, one or more sensors from which sensor data is to be aggregated (act 206). The sensor system (e.g., the sensor selection module) is aware of the sensors supported by the computing device. A sensor being supported by the computing device refers to a sensor from which sensor data can be received and aggregated by the sensor system. A combination of multiple sensors being supported refers to multiple sensors from which sensor data can be received and aggregated by the sensor system. These sensors can include sensors that are included in the computing device as well as any other sensors coupled to the computing device or from which the computing device can receive sensor data. Sensors from which sensor data cannot be received and aggregated are not supported by the computing device (the computing device lacks support for such sensors), and combinations of sensors from which data cannot be received and aggregated are not supported by the computing device (the computing device lacks support for such combinations of sensors). The sensor system can be made aware of the sensors supported by the computing device in a variety of different manners, such as by being pre-configured with an indication of the sensors supported, identifying the sensors dynamically during operation of the computing device (e.g., as sensors or device drivers register with or otherwise make the operating system aware of the sensors), obtaining an indication from another device or service of the sensors supported, and so forth.

The sensor system (e.g., the sensor selection module) is also aware of the characteristics of each supported sensor. The sensor system can be made aware of the sensor characteristics of the supported sensors in a variety of different manners, such as by being pre-configured with an indication of the sensor characteristics of the supported sensors, identifying the sensor characteristics of the supported sensors dynamically during operation of the computing device (e.g., as sensors or device drivers register with or otherwise make the operating system aware of the sensors), obtaining an indication from another device or service of the sensor characteristics of the supported sensors, and so forth.

Various different sensors can be supported by the computing device, such as an accelerometer, a magnetometer, a gyroscope, a pedometer, a barometer, a photo sensor, a thermometer, and so forth. It should be noted, however, that these sensors are examples of sensors that can be supported by the computing device, and that other physical or heuristic sensors can additionally or alternatively be supported by the computing device. These sensors can optionally have two or more different operating modes, such as a low power mode that uses a small amount of power but provides less accurate sensor data, and a high power mode that uses a larger amount of power but provides more accurate sensor data. These different modes can be treated by the sensor system as different modes of the same sensor, so that the particular mode to activate the sensor in is also identified in act 206. Alternatively, these different modes can be treated by the sensor system as different sensors (e.g., one sensor that provides less accurate sensor data and uses less power, and another sensor that provides more accurate sensor data and uses more power).

The sensor selection module can use any of a variety of different rules, criteria, mappings, algorithms, and so forth to identify sensors in act 206. The identified sensors that are not already activated are activated (optionally in the appropriate mode as discussed above). Activating a sensor refers to powering on, waking up, or otherwise putting a sensor in a state in which the sensor can provide sensor data to the sensor system. In one or more embodiments, the sensor selection module maintains a predetermined mapping that indicates, for a particular combination of supported sensors and indicated sensor characteristics to be prioritized, which one or more sensors are identified in act 206.

In one or more embodiments, the rules, criteria, mappings, algorithms, and so forth used to identify sensors in act 206 have one or more possible combinations of sensors that are identified based on which sensors are supported by the computing device. The possible combinations are ranked, with the highest ranked combination identified as the combination in act 206. Thus, the sensor system can have a first choice and one or more fallback positions. For example, the highest ranked combination may be a combination of the accelerometer, gyroscope, and magnetometer sensors, but if the combination of those three sensors is not supported by the computing device then the fallback (next highest ranked combination) may be a combination of the accelerometer and magnetometer sensors.

Sensor data from the identified sensors is aggregated to generate aggregated data (act 208). As indicated above, aggregating the obtained sensor data refers to combining the sensor data so that a combined value is returned to the requesting program rather than the individual sensor data. However, in situations in which a single sensor is identified in act 206, the aggregated data can be the sensor data from the single sensor.

The sensor data from multiple sensors can be aggregated in a variety of different manners using any of a variety of different rules, criteria, mappings, algorithms, and so forth. The sensor data from multiple sensors can be aggregated using any of a variety of public and/or proprietary techniques. The combining of sensor data into a single aggregated value is also referred to as sensor fusion. For example, the aggregated value can be an indication of the orientation of the computing device in 3D space, the orientation being indicated in degrees of roll, pitch, and yaw (e.g., about the y-axis, x-axis, and z-axis, respectively, in 3D space) generated from sensor data from one or more of three sensors: an accelerometer, a gyroscope, and a magnetometer. The aggregated value can be generated by using the gyroscope to determine an orientation of the computing device, and applying a correction factor to the orientation determined by the gyroscope using a feedback control signal based on motion data obtained from the accelerometer or magnetometer to reduce drift in motion data obtained from the gyroscope.

The aggregated data is returned to the program that requested the data (act 210). The sensing priority interface returns the aggregated data to the program, which can then use the returned data as desired. Acts 204-210 can be repeated as desired, for example each time the program desires an aggregated value.

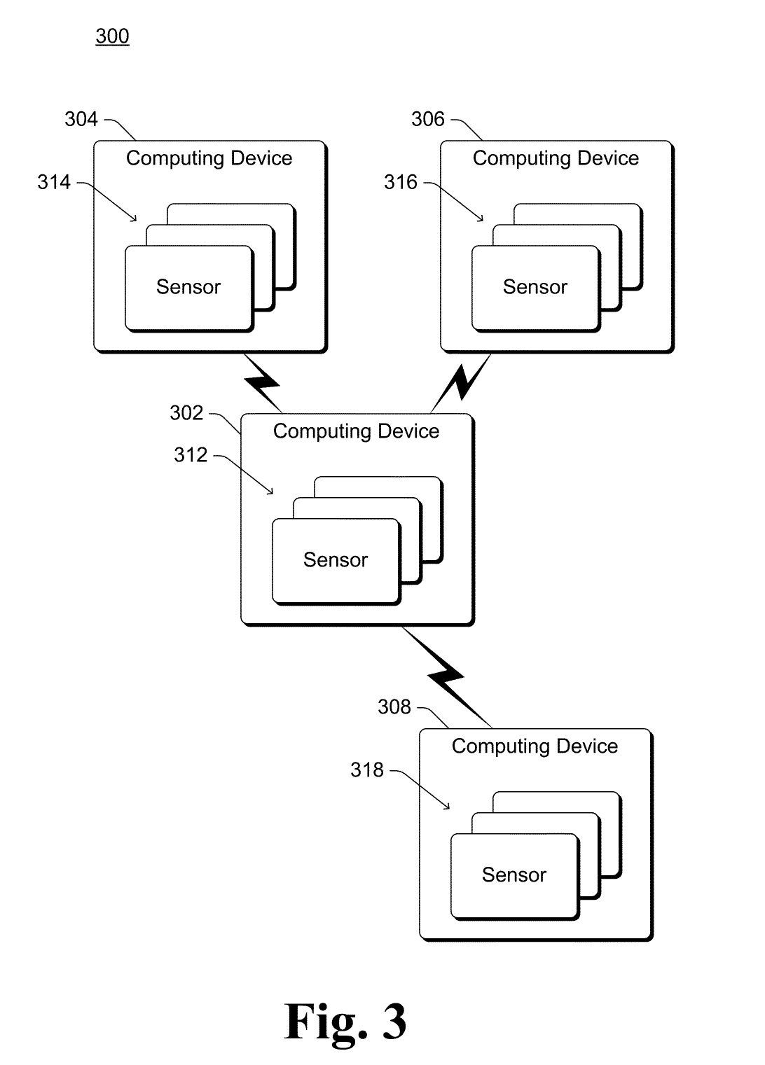

In one or more embodiments, situations can arise in which a computing device is physically situated close enough to (e.g., within a threshold distance of) another device that the computing device can obtain data from a sensor of that other device. FIG. 3 illustrates an example system 300 in which the automatic sensor selection based on requested sensor characteristics can be implemented in accordance with one or more embodiments. The system 300 includes multiple computing devices 302, 304, 306, and 308, each including one or more sensors 312, 314, 316, and 318, respectively. The computing device 302 can communicate with the computing devices 304, 306, and 308 using any of a variety of different wireless or wired communication mechanisms. For example, these communication mechanisms can include Bluetooth, infrared, wireless universal serial bus (wireless USB), near field communication (NFC), and so forth. These communication mechanisms can also include one or more networks, such as a local area network (LAN), the Internet, a phone (e.g., cellular) network, and so forth.

The computing device 302 can be made aware of the types of sensors supported by each of the computing devices 304, 306, and 308, as well as the sensor characteristics of those supported sensors. The sensor system can take these sensor types and sensor characteristics into consideration when identifying the multiple sensors from which the sensor data is to be aggregated in act 206 of FIG. 2. For example, the sensors 314 may include a thermometer but the sensors 312 may not include a thermometer. In this situation, the computing device 302 can obtain sensor data from the thermometer of the computing device 304. By way of another example, the sensors 316 may include a pedometer with different characteristics (e.g., higher accuracy) than a pedometer included in the sensors 312. In this situation, the computing device 302 can obtain sensor data from the pedometer of the computing device 306.

Returning to FIG. 2, the following is an example of generating aggregated data in a computing device, the aggregated data being an indication of the position and orientation of the computing device in 3D space. The computing device supports at least three sensors, including an accelerometer, a gyroscope, and a magnetometer. The indication of one or more sensor characteristics that are to be prioritized include any one, or any combination of, heading accuracy, rotation rate accuracy, and power efficiency.

In response to an indication that heading accuracy is the one or more sensor characteristics to be prioritized, in act 206 the sensor selection module identifies the accelerometer, gyroscope, and magnetometer sensors as the sensors from which sensor data is to be aggregated. If the computing device does not support aggregating data from the accelerometer, gyroscope, and magnetometer sensors, then in act 206 the sensor selection module identifies the accelerometer and magnetometer sensors as the sensors from which sensor data is to be aggregated.

In response to an indication that rotation rate accuracy is the one or more sensor characteristics to be prioritized, in act 206 the sensor selection module identifies the accelerometer, gyroscope, and magnetometer sensors as the sensors from which sensor data is to be aggregated. If the computing device does not support aggregating data from the accelerometer, gyroscope, and magnetometer sensors, then in act 206 the sensor selection module identifies the accelerometer and gyroscope sensors as the sensors from which sensor data is to be aggregated. If the computing device does not support aggregating data from the accelerometer and gyroscope sensors, then in act 206 the sensor selection module identifies the accelerometer and magnetometer sensors as the sensors from which sensor data is to be aggregated.

In response to an indication that power efficiency is the one or more sensor characteristics to be prioritized, in act 206 the sensor selection module identifies the accelerometer and magnetometer sensors as the sensors from which sensor data is to be aggregated. If the computing device does not support aggregating data from the accelerometer and magnetometer sensors, then in act 206 the sensor selection module identifies the accelerometer and gyroscope sensors as the sensors from which sensor data is to be aggregated. If the computing device does not support aggregating data from the accelerometer and gyroscope sensors, then in act 206 the sensor selection module identifies the accelerometer, gyroscope, and magnetometer sensors as the sensors from which sensor data is to be aggregated.

In response to an indication that heading accuracy and rotation rate accuracy are the one or more sensor characteristics to be prioritized, in act 206 the sensor selection module identifies the accelerometer, gyroscope, and magnetometer sensors as the sensors from which sensor data is to be aggregated. If the computing device does not support aggregating data from the accelerometer, gyroscope, and magnetometer sensors, then in act 206 the sensor selection module identifies the accelerometer and magnetometer sensors as the sensors from which sensor data is to be aggregated.

In response to an indication that heading accuracy and power efficiency are the one or more sensor characteristics to be prioritized, in act 206 the sensor selection module identifies the accelerometer and magnetometer sensors as the sensors from which sensor data is to be aggregated.

In response to an indication that rotation rate accuracy and power efficiency are the one or more sensor characteristics to be prioritized, in act 206 the sensor selection module identifies the accelerometer and gyroscope sensors as the sensors from which sensor data is to be aggregated. If the computing device does not support aggregating data from the accelerometer and gyroscope sensors, then in act 206 the sensor selection module identifies the accelerometer and magnetometer sensors as the sensors from which sensor data is to be aggregated.

In response to an indication that heading accuracy, rotation rate accuracy, and power efficiency are the one or more sensor characteristics to be prioritized, in act 206 the sensor selection module identifies the accelerometer and magnetometer sensors as the sensors from which sensor data is to be aggregated.

In response to an indication that no sensor characteristics are to be prioritized, in act 206 the sensor selection module identifies the accelerometer, gyroscope, and magnetometer sensors as the sensors from which sensor data is to be aggregated. If the computing device does not support aggregating data from the accelerometer, gyroscope, and magnetometer sensors, then in act 206 the sensor selection module identifies the accelerometer and magnetometer sensors as the sensors from which sensor data is to be aggregated. If the computing device does not support aggregating data from the accelerometer and magnetometer sensors, then in act 206 the sensor selection module identifies the accelerometer and gyroscope sensors as the sensors from which sensor data is to be aggregated.

In one more embodiments, the sensor data is used to generate the aggregated data only after receiving user consent to do so. This user consent can be an opt-in consent, where the user takes an affirmative action to request that the sensor data be used. Alternatively, this user consent can be an opt-out consent, where the user takes an affirmative action to request that the data not be used. If the user does not choose to opt out of this sensor data usage, then it is an implied consent by the user to use the sensor data.

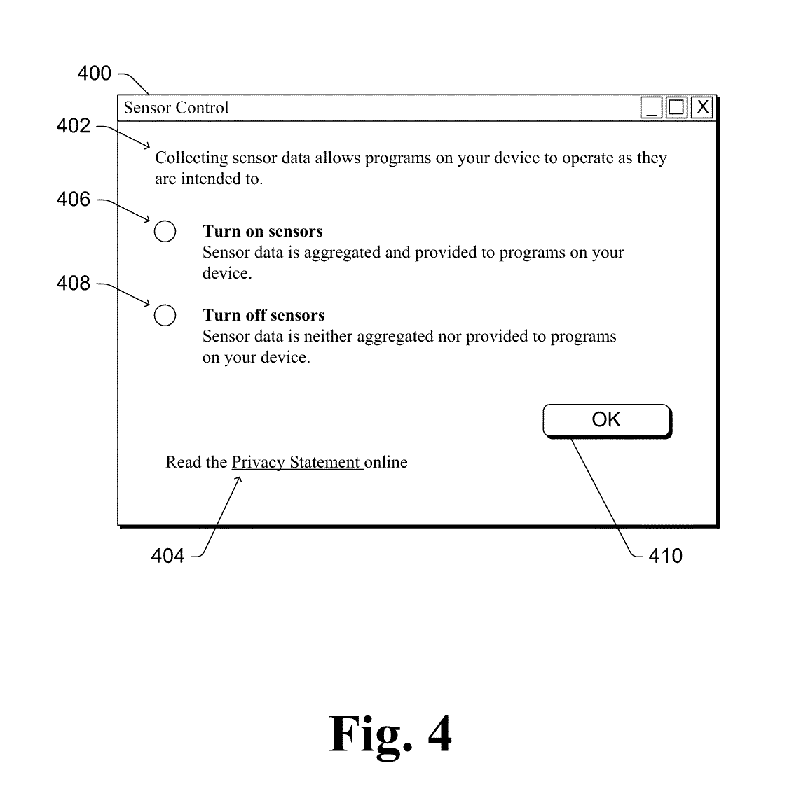

FIG. 4 illustrates an example user interface that can be displayed to a user to allow the user to select whether to use sensor data in accordance with one or more embodiments. A sensor control window 400 is displayed including a description 402 explaining to the user why sensor data is collected. A link 404 to a privacy statement is also displayed. If the user selects link 404, a privacy statement is displayed, explaining to the user how the user's information is kept confidential.

Additionally, the user is able to select a radio button 406 to opt-in to the sensor usage, or a radio button 408 to opt-out of the sensor usage. Once a radio button 406 or 408 is selected, the user can select an “OK” button 410 to have the selection saved. It is to be appreciated that radio buttons and an “OK” button are only examples of user interfaces that can be presented to a user to opt-in or opt-out of the tracking, and that a variety of other conventional user interface techniques can alternatively be used. The sensor system then proceeds to either use sensor data or not use sensor data in accordance with the user's selection.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

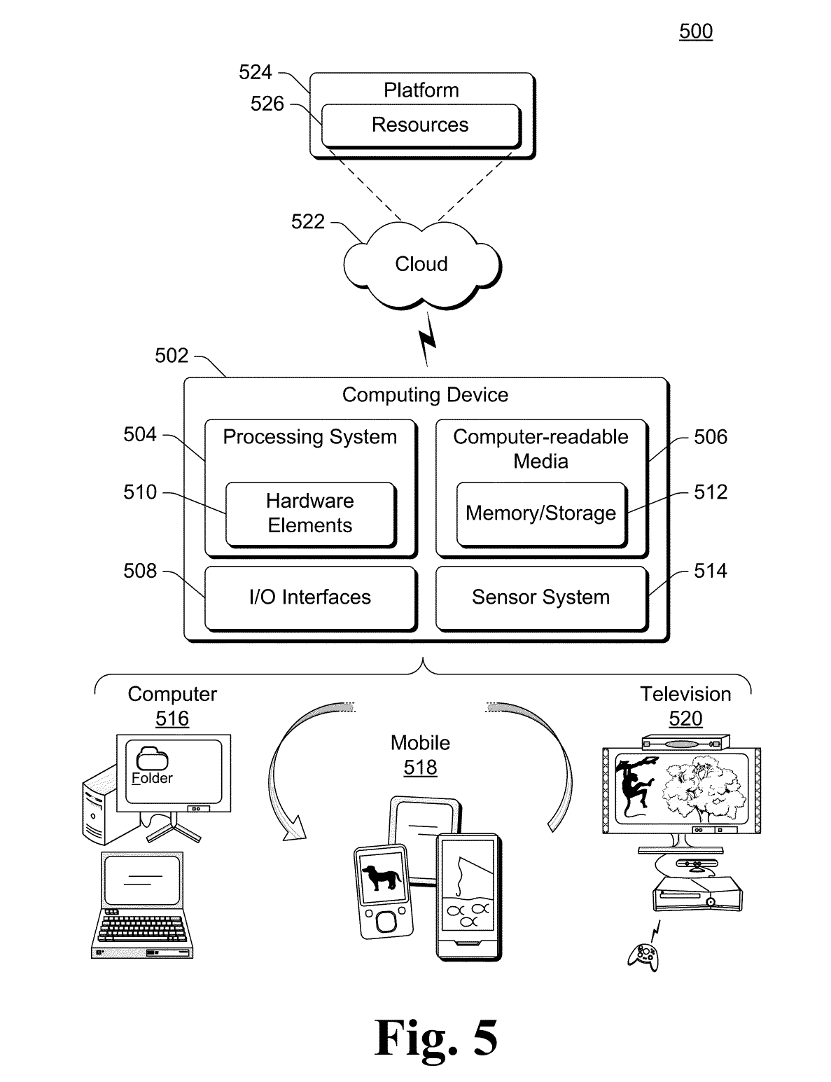

FIG. 5 illustrates an example system generally at 500 that includes an example computing device 502 that is representative of one or more systems and/or devices that may implement the various techniques described herein. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O Interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 502 may be configured in a variety of ways as further described below to support user interaction.

Computing device 502 also includes a sensor system 514. The sensor system 514 automatically selects sensors from which sensor data is to be aggregated based on sensor characteristics requested by the program, as discussed above. The sensor system 514 can implement, for example, the sensor system 102 of FIG. 1.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of modules as a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 502 may assume a variety of different configurations, such as for computer 516, mobile 518, and television 520 uses. Each of these configurations includes devices that may have generally different constructs and capabilities, and thus the computing device 502 may be configured according to one or more of the different device classes. For instance, the computing device 502 may be implemented as the computer 516 class of a device that includes a personal computer, desktop computer, a multi-screen computer, laptop computer, netbook, and so on.

The computing device 502 may also be implemented as the mobile 518 class of device that includes mobile devices, such as a mobile phone, portable music player, portable gaming device, a tablet computer, a multi-screen computer, and so on. The computing device 502 may also be implemented as the television 520 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This functionality may also be implemented all or in part through use of a distributed system, such as over a “cloud” 522 via a platform 524 as described below.

The cloud 522 includes and/or is representative of a platform 524 for resources 526. The platform 524 abstracts underlying functionality of hardware (e.g., servers) and software resources of the cloud 522. The resources 526 may include applications and/or data that can be utilized while computer processing is executed on servers that are remote from the computing device 502. Resources 526 can also include services provided over the Internet and/or through a subscriber network, such as a cellular or Wi-Fi network.

The platform 524 may abstract resources and functions to connect the computing device 502 with other computing devices. The platform 524 may also serve to abstract scaling of resources to provide a corresponding level of scale to encountered demand for the resources 526 that are implemented via the platform 524. Accordingly, in an interconnected device embodiment, implementation of functionality described herein may be distributed throughout the system 500. For example, the functionality may be implemented in part on the computing device 502 as well as via the platform 524 that abstracts the functionality of the cloud 522.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method implemented in a computing device comprises exposing a sensing priority interface having a parameter that is an indication of one or more sensor characteristics that are to be prioritized; and in response to the sensing priority interface being invoked by a program that provides the indication of one or more sensor characteristics that are to be prioritized, identifying, based on the indication of the one or more sensor characteristics that are to be prioritized, one or more of multiple sensors from which sensor data is to be aggregated, aggregating the sensor data from the one or more sensors, and returning the aggregated data to the program.

Alternatively or in addition to the above described method, any one or combination of: the multiple sensors including an accelerometer, a magnetometer, and a gyroscope, and the aggregated data comprising a 3-dimensional position and orientation of the computing device in 3D space; the one or more sensor characteristics comprising one or more sensor characteristics selected from the group including: heading accuracy, rotation rate accuracy, and power efficiency; the identifying further comprising identifying the one or more sensors based on sensors supported by the computing device; the multiple sensors comprising two or more sensors selected from the group including: an accelerometer, a magnetometer, a gyroscope, a pedometer, a barometer, a photo sensor, and a thermometer; the one or more sensor characteristics comprising one or more sensor characteristics selected from the group including: heading accuracy, rotation rate accuracy, power efficiency, spatial distance accuracy, calorie expenditure impact accuracy, latency of sensing data, and CPU usage; the method being implemented in an operating system of the computing device; the program having no prior or run-time knowledge of the sensors supported by the computing device; the identifying further comprising determining a highest ranked combination of sensors and a fallback combination of sensors to identify in response to the computing device lacking support for the highest ranked combination of sensors; the one or more sensors including a sensor situated on another device separate from the computing device.

A computing device comprises a processing system comprising one or more processors; and one or more computer-readable storage media having stored thereon multiple instructions that, when executed by the processing system, cause the processing system to perform acts including: exposing a sensing priority interface receiving as a parameter an indication of which of multiple sensor characteristics are to be prioritized; in response to the sensing priority interface being called by a program of the computing device, identifying, based on the indication of which of multiple sensor characteristics are to be prioritized, one or more of multiple sensors, aggregating sensor data from the one or more sensors, and returning the aggregated data to the program.

Alternatively or in addition to the above described computing device, any one or combination of: the multiple sensors including an accelerometer, a magnetometer, and a gyroscope, and the aggregated data comprising a 3-dimensional position and orientation of the computing device in 3D space; the multiple sensor characteristics including heading accuracy, rotation rate accuracy, and power efficiency; the identifying further comprising identifying the one or more sensors based on combinations of sensors supported by the computing device; the multiple sensors comprising two or more sensors selected from the group including: an accelerometer, a magnetometer, a gyroscope, a pedometer, a barometer, a photo sensor, and a thermometer; the multiple sensor characteristics including heading accuracy, rotation rate accuracy, power efficiency, spatial distance accuracy, calorie expenditure impact accuracy, latency of sensing data, and CPU usage; the multiple instructions being part of an operating system of the computing device; the program having no prior or run-time knowledge of the sensors supported by the computing device; the one or more sensors including a sensor situated on another device separate from the computing device.

A method implemented in a computing device comprises exposing an API method having a parameter that is an indication of one or more sensor characteristics that are to be prioritized, the one or more sensor characteristics comprising one or more sensor characteristics selected from the group including heading accuracy, rotation rate accuracy, and power efficiency; and in response to the API method being invoked by a program running on the computing device, the program having no prior or run-time knowledge of the sensors supported by the computing device, and the program providing the indication of one or more sensor characteristics that are to be prioritized, identifying, based on the indication of the one or more sensor characteristics that are to be prioritized, multiple sensors from which sensor data is to be aggregated, the multiple sensors including an accelerometer, a magnetometer, and a gyroscope, aggregating the sensor data from the multiple sensors, the aggregated data comprises a 3D position and orientation of the computing device in 3D space, and returning the aggregated data to the program.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a computing device, the method comprising:
exposing a sensing priority interface having a parameter that is an indication of one or more sensor characteristics that are to be prioritized; and
in response to the sensing priority interface being invoked by a program that provides the indication of one or more sensor characteristics that are to be prioritized,
identifying, based on the indication of the one or more sensor characteristics that are to be prioritized, one or more of multiple sensors from which sensor data is to be aggregated,
aggregating the sensor data from the one or more sensors, and
returning the aggregated data to the program.

2. The method as recited in claim 1, the multiple sensors including an accelerometer, a magnetometer, and a gyroscope, and the aggregated data comprising a 3-dimensional position and orientation of the computing device in 3D space.

3. The method as recited in claim 2, the one or more sensor characteristics comprising one or more sensor characteristics selected from the group including: heading accuracy, rotation rate accuracy, and power efficiency.

4. The method as recited in claim 1, the identifying further comprising identifying the one or more sensors based on sensors supported by the computing device.

5. The method as recited in claim 1, the multiple sensors comprising two or more sensors selected from the group including: an accelerometer, a magnetometer, a gyroscope, a pedometer, a barometer, a photo sensor, and a thermometer.

6. The method as recited in claim 1, the one or more sensor characteristics comprising one or more sensor characteristics selected from the group including: heading accuracy, rotation rate accuracy, power efficiency, spatial distance accuracy, calorie expenditure impact accuracy, latency of sensing data, and CPU usage.

7. The method as recited in claim 1, the method being implemented in an operating system of the computing device.

8. The method as recited in claim 1, the program having no prior or run-time knowledge of the sensors supported by the computing device.

9. The method as recited in claim 1, the identifying further comprising determining a highest ranked combination of sensors and a fallback combination of sensors to identify in response to the computing device lacking support for the highest ranked combination of sensors.

10. The method as recited in claim 1, the one or more sensors including a sensor situated on another device separate from the computing device.

11. A computing device comprising:
a processing system comprising one or more processors; and
one or more computer-readable storage media having stored thereon multiple instructions that, when executed by the processing system, cause the processing system to perform acts including:
exposing a sensing priority interface receiving as a parameter an indication of which of multiple sensor characteristics are to be prioritized;
in response to the sensing priority interface being called by a program of the computing device,
identifying, based on the indication of which of multiple sensor characteristics are to be prioritized, one or more of multiple sensors,
aggregating sensor data from the one or more sensors, and
returning the aggregated data to the program.

12. The computing device as recited in claim 11, the multiple sensors including an accelerometer, a magnetometer, and a gyroscope, and the aggregated data comprising a 3-dimensional position and orientation of the computing device in 3D space.

13. The computing device as recited in claim 12, the multiple sensor characteristics including heading accuracy, rotation rate accuracy, and power efficiency.

14. The computing device as recited in claim 11, the identifying further comprising identifying the one or more sensors based on combinations of sensors supported by the computing device.

15. The computing device as recited in claim 11, the multiple sensors comprising two or more sensors selected from the group including: an accelerometer, a magnetometer, a gyroscope, a pedometer, a barometer, a photo sensor, and a thermometer.

16. The computing device as recited in claim 11, the multiple sensor characteristics including heading accuracy, rotation rate accuracy, power efficiency, spatial distance accuracy, calorie expenditure impact accuracy, latency of sensing data, and CPU usage.

17. The computing device as recited in claim 11, the multiple instructions being part of an operating system of the computing device.

18. The computing device as recited in claim 11, the program having no prior or run-time knowledge of the sensors supported by the computing device.

19. The computing device as recited in claim 11, the one or more sensors including a sensor situated on another device separate from the computing device.

20. A method implemented in a computing device, the method comprising:
exposing an API method having a parameter that is an indication of one or more sensor characteristics that are to be prioritized, the one or more sensor characteristics comprising one or more sensor characteristics selected from the group including heading accuracy, rotation rate accuracy, and power efficiency; and
in response to the API method being invoked by a program running on the computing device, the program having no prior or run-time knowledge of the sensors supported by the computing device, and the program providing the indication of one or more sensor characteristics that are to be prioritized,
identifying, based on the indication of the one or more sensor characteristics that are to be prioritized, multiple sensors from which sensor data is to be aggregated, the multiple sensors including an accelerometer, a magnetometer, and a gyroscope,
aggregating the sensor data from the multiple sensors, the aggregated data comprises a 3D position and orientation of the computing device in 3D space, and
returning the aggregated data to the program.
